(19) United States
(12) Patent Application Publication
(10) Pub. No.: US 2026/0300639 A1
(43) Pub. Date: Oct. 1, 2026

(54) GENERATING COREFERENCE MATCHES FOR AN ENTITY UTILIZING A COMBINED LARGE LANGUAGE MODEL

(71) Applicant: Ancestry.com Operations Inc., Lehi, UT (US)

(72) Inventors: Sina Mahdipour Saravani, Salt Lake City, UT (US); Vishwajeet Vijay Paradkar, Fremont, CA (US); Suraj Subraveti, San Francisco, CA (US)

(21) Appl. No.: 19/089,960

(22) Filed: Mar. 25, 2025

(51) Int. Cl. G06F 40/40

(52) U.S. Cl. CPC G06F 40/40

(57) ABSTRACT

The present disclosure is directed toward systems, methods, and non-transitory computer-readable media that determines which reference instances in a text (e.g., a genealogical-record text) refer to the same entity. In particular, the disclosed systems can analyze a genealogical-record text and detect reference instances within the genealogical-record text and can utilize a combined multi-model architecture that includes a model-selection router and a plurality of candidate entity-matching large language models (LLMs). In some embodiments, the disclosed systems use the model-selection router to determine and select one or more entity-matching LLMs corresponding to reference types of the reference instances. Utilizing the selected entity-matching LLM(s), the disclosed systems can generate a coreference match for a specific entity by linking one or more of the reference instances to each other.

### BACKGROUND

In the field of genealogical text analysis, existing systems can provide some opportunities to identify and match references (or expressions) that refer to a particular entity. For instance, some existing systems rely on user input and manual entity referencing to associate text references with an entity. As another example, some existing systems rely on a form of natural language processing (NLP) to associate references with an entity. For instance, some existing systems utilize an NLP model to analyze a text, identify entity references from with the text, and infer an association between the entity references and a particular entity. Nevertheless, existing systems exhibit a number of deficiencies or drawbacks, particularly in relation to accuracy, efficiency, and flexibility.

As just suggested, some existing systems are inaccurate. For example, existing systems that rely on user input and manual entity referencing typically suffer from human errors, including inconsistent labeling and/or incorrect or undetected coreference matches (or linking). Moreover, because such systems rely on user input, they are often prone to bias, resulting in significant variations in accuracy across datasets and domains.

Further, for existing systems that rely on NLP, such systems typically depend on a single, shared machine learning model that attempts to resolve all types of coreference relationships without distinction. By relying solely on a monolithic NLP model, existing systems are prone to errors in coreference matching due to the overgeneralized nature of the single model which struggles to adapt to wide varieties of text references. Experimenters have demonstrated that such models struggle with a number of reference tasks, including: (1) ambiguous references, where a single mention could refer to multiple possible entities; (2) pronoun resolution, where gender, number, or proximity heuristics alone are insufficient; (3) long-range dependencies, where entities referenced at different parts of a document are incorrectly linked or left unlinked; and/or (4) rare or unrecognized (e.g., domain specific) entities, which the model has not encountered (or encountered frequently) during training. Indeed, by relying on a generalized model trained on a specific dataset, existing systems fail to prioritize or recognize specific types of references or contextually significant mentions, causing a lack of precision in coreference matching. These models, while effective at handling some broad cases, struggle to differentiate between nuanced coreference patterns, particularly those requiring contextual understanding, domain-specific knowledge, or error tolerance for informal and misspelled text.

Additionally, existing NLP-based systems problematically fail to resolve entities together, resulting in an excessive number of detected entities from a text, such as a genealogical-record text, where many of the detected entities are duplicative over one another and should have been resolved together. This increases a computational-resource workload associated with such tasks and reduces accuracy of relationships detected between entities while also resulting in a less emotionally satisfying and efficient customer experience. Further, an excessive number of detected entities raises pressure and cost associated with downstream annotations of said texts.

Moreover, as mentioned above, existing systems are inefficient. Specifically, due in part to their inaccuracies, many existing systems struggle to associate reference instances in a text or across multiple texts to a single entity. To remedy these issues, existing systems often access and search large amounts of data across various databases to combine information and make predictions on entities. Accessing and processing data from numerous databases (in addition to processing the text body itself) consumes excessive computational resources, such as processing power and memory, that could otherwise be preserved with a more efficient system.

As further mentioned above, existing systems are inflexible. In particular, many existing systems are only capable of detecting very specific types of entity references, such as specific pronouns or named entities. Such existing systems are rigidly fixed to these specific entities, often due to training data constraints, and consequently struggle to adapt to other reference types (e.g., indirect references, implicit references such as zero anaphora, appositive phrases, and/or event references), unknown references, and/or textually inconsistent (e.g. misspelled) references. Further, many existing systems are often fixed to detecting references in English text. Accordingly, existing systems are frequently unable to adapt to detecting and decoding record texts written in other languages and thus cannot generate coreference matches for references contained in non-English records. Further, many such systems are rigidly fixed to particular contexts, such as newspaper articles, and are not robust to application to different contexts from which resolvable entities may be extracted, such as Census records and family history books.

These along with additional problems and issues exist with regard to existing systems.

### SUMMARY

This disclosure describes one or more embodiments of systems, methods, and non-transitory computer-readable storage media that provide benefits and/or solve one or more of the foregoing and other problems in the art. In particular, the disclosed systems introduce a unique approach to determining which reference instances in a text (e.g., a genealogical-record text) refer to the same entity. In particular, the disclosed systems can analyze a genealogical-record text and detect reference instances within the genealogical-record text. The disclosed systems can also send (or provide) the data associated with the reference instances to a model-selection router. In some embodiments, the disclosed systems use the model-selection router to determine an entity-matching large language model (LLM), as part of a combined-LLM model such as a mixture of experts or “MOE,” to process the data associated with the reference instances. Utilizing the selected entity-matching LLM, the disclosed systems can generate a coreference match for a specific entity by linking one or more of the reference instances to each other.

### BRIEF DESCRIPTION OF THE DRAWINGS

The detailed description provides one or more embodiments with additional specificity and detail through the accompanying drawings, as briefly described below.

FIG. 1 illustrates a schematic diagram of an example system environment for implementing a coreference-determination system in accordance with one or more embodiments.

FIG. 2 illustrates an example diagram of utilizing an entity-matching LLM to generate a coreference match for an entity in accordance with one or more embodiments.

FIG. 3 illustrates an example diagram of a hierarchical entity-matching architecture utilized by a coreference-determination system in accordance with one or more embodiments.

FIG. 4 illustrates an example diagram of selecting an entity-matching LLM based on determining a reference type for each reference instance in a reference pair in accordance with one or more embodiments.

FIG. 5 illustrates an example diagram of directing a reference pair to an alternative-reference LLM in accordance with one or more embodiments.

FIG. 6 illustrates an example diagram of generating a coreference match for an entity by utilizing a plurality of candidate entity-matching LLMs within a combined-LLM model in accordance with one or more embodiments.

FIGS. 7A-7B illustrate example user interfaces for generating coreference clusters in accordance with one or more embodiments.

FIG. 8 illustrates an example flowchart of a series of acts for generating a coreference match for an entity in accordance with one or more embodiments.

FIG. 9 illustrates a block diagram of an exemplary computing device for implementing one or more embodiments of the present disclosure.

FIG. 10 illustrates an example environment of a genealogical data system including a coreference-determination system in accordance with one or more embodiments.

### DETAILED DESCRIPTION

This disclosure describes one or more embodiments of a coreference-determination system 100 that can determine which reference instances in a genealogical-record text refer to a common, shared, or same entity. In particular, the coreference-determination system 100 can analyze a text (e.g., a genealogical-record text) and detect reference instances within the text. Using, e.g., a multilingual encoder, the coreference-determination system 100 can generate vector representations of the one or more reference instances and can send (or provide) the vector representations to a model-selection router. In some embodiments, the coreference-determination system 100 uses the model-selection router to select an appropriate entity-matching large language model (LLM) from among a plurality of candidate entity-matching LLMs within a combined-LLM model. Utilizing the entity-matching LLM, the coreference-determination system 100 may generate a coreference match for a specific entity by linking one or more of the reference instances to each other. In the same or other embodiments, the coreference-determination system 100 can link the coreference match to other reference instances or coreference matches, thereby generating a coreference cluster.

In one or more embodiments, the coreference-determination system 100 can provide several improvements or advantages over existing systems. For instance, the coreference-determination system 100 can improve accuracy over existing systems. To elaborate, rather than solely or predominately relying on user input and/or a monolithic model, the coreference-determination system 100 can utilize a combined-LLM model (e.g., a mixture of experts or MOE model) design to match (or link) reference instances contained in a genealogical-record text. In particular, the coreference-determination system 100 can detect a plurality of reference instances in a genealogical-record text, determine that each reference instance in the plurality of reference instances corresponds to a particular type of reference, and can route reference instances to a particular entity-matching LLM for analysis. By utilizing the combined-LLM model design, the coreference-determination system 100 may be capable of specializing in different types of coreference relationships (including some not recognized by prior systems), reducing the inaccuracies that can be caused by a single, generalized model as in previous systems. For instance, instead of applying a one-size-fits-all approach, the coreference-determination system 100 can categorize reference pairs (or reference groups) into specific reference types (e.g., linguistic types, such as pronoun-pronoun, entity-pronoun, and/or entity-entity) and can assign a dedicated entity-matching LLM (e.g., expert scorer) to each category. Indeed, each entity-matching LLM can be trained specifically for its corresponding category (e.g., entity-entity), making it better suited to recognize and resolve particular types of reference pairs (or reference groups) than a monolithic model.

Furthermore, utilizing the combined-LLM model design allows for more context-aware decision-making, significantly improving coreference-matching performance on ambiguous or complex cases. In particular, existing systems struggle with ambiguous reference instances, pronoun resolution, long-range dependencies, and/or rare or unrecognized entities, leading to incorrect or unidentified coreference matches. In contrast, by utilization of the combined-LLM model design, the coreference-determination system 100 facilitates handling different coreference types by entity-matching LLMs that are specifically optimized for respective types.

For example, the coreference-determination system 100 can improve pronoun resolution (e.g., a process of identifying a correct antecedent or referent of a pronoun) by utilizing entity-matching LLMs—such as a pronoun-pronoun LLM and/or a pronoun-entity (also referred to as entity-pronoun) LLM—to account for gender and/or number agreement. As another example, the coreference-determination system 100 can improve entity-entity resolution (e.g., a process of identifying different noun phrases, names, and/or expressions that refer to the same named entity) by utilizing entity-matching LLMs—such as an entity-entity LLM and/or a pronoun-entity LLM—to prioritize lexical similarity and/or contextual coherence. Moreover, when at least one reference instance is not a pronoun reference, an entity reference (e.g., named entity), a known reference, or a textually consistent (e.g., correctly spelled) reference, the coreference-determination system 100 can benefit from selecting an alternative-reference LLM that can analyze the context of a genealogical-record text to generate a coreference match. By combining the strengths of multiple specialized expert models, the coreference-determination system 100 can thus achieve higher precision, fewer false positives, and/or improved generalization across different datasets and domains.

Moreover, the coreference-determination system 100 can improve efficiency relative to existing systems. In particular, not only can the coreference-determination system 100 more accurately match (or link) reference instances contained in a specific genealogical-record text to an entity but it can also match (or link) reference instances contained in a plurality of genealogical-record texts (e.g., across one or more databases) to the entity. The coreference-determination system 100 can thus clean up duplicate records and/or generate an entity-matching web that can link together reference instances corresponding to the entity by analyzing the genealogical-record texts (in many cases without accessing external data to compare and process). By so doing, the coreference-determination system 100 can preserve time and computational resources when storing, searching, and/or accessing genealogical-record texts.

In addition to improving accuracy and efficiency, the coreference-determination system 100 also improves functionality and flexibility relative to existing systems. To elaborate, in contrast with existing systems, the coreference-determination system 100 can process and identify a wider array of coreference types than prior systems. To elaborate, the coreference-determination system 100 can detect that at least one reference in a reference pair (or reference group) is not a pronoun reference, an entity (e.g., a named entity) reference, a known reference, or a textually consistent (e.g., correctly spelled) reference. Based on this determination, the coreference-determination system 100 can direct (or route) the at least one reference to an alternative-reference LLM for generating a coreference match for an entity. Indeed, by utilizing the alternative-reference LLM, the coreference-determination system 100 can leverage contextual embeddings of a genealogical-record text to determine that the reference instances in the reference pair (or reference group) refer to the same entity.

Moreover, in further contrast to existing systems that are often only capable of encoding English text, the coreference-determination system 100 improves functionality and flexibility by using a multilingual encoder and/or a model-selection router. In particular, the coreference-determination system 100 can utilize a multilingual encoder that is pre-trained on data associated with a plurality of languages to generate vector representations of the reference instances. In some embodiments, the model-selection router can receive the vector representations of the reference instances, leverage multilingual heuristics to process the vector representations, and dynamically direct (or provide) the vector representations to a specific (and/or appropriate) entity-matching LLM for analysis. Based on the output(s) of the multilingual encoder, the coreference-determination system 100 can also fine-tune the combined-LLM model, thereby enabling each entity-matching LLM to determine how vector representations of potentially multilingual sources are similar and/or distinct. Accordingly, in at least one embodiment, the multilingual encoder and the model-selection router enable the coreference-determination system 100 to handle cross-lingual entity matching, allowing the coreference-determination system 100 to accurately resolve references even when a genealogical-record text (or part of a genealogical-record text) appears in a non-English language and/or in different languages.

As illustrated by the foregoing (and following) discussion, the present disclosure utilizes a variety of terms to describe features and advantages of the coreference-determination system 100. Additional detail is now provided regarding the meaning of such terms. As used herein, the term “genealogical-record text” refers to a written document, structured dataset, and/or a manuscript that contains genealogical and/or historical data. For instance, genealogical-record texts may contain data about individuals, family relationships, ancestral lineage, genetic information, and/or historical information. A genealogical-record text may also contain biographical details, occupations, locations, dates, and/or familial ties. Examples of genealogical-record texts includes, without limitation, Census records, birth, marriage, and death records, military records, other government records, family history books, journals, pedigrees, newspaper articles, or other suitable records from which genealogical or other information may be derived.

As also used herein, the term “reference instance” (or “reference”) refers to an occurrence of a word, phrase, or expression within a text (e.g., a genealogical-record text) that refers to a specific entity. For instance, a reference instance serves as a linguistic pointer to an antecedent or entity, which may be explicitly mentioned in the text or inferred (by an LLM) through context. In one or more embodiments, a reference instance can correspond to a reference type of a plurality of reference types. For example, a reference instance can correspond to a pronoun reference (or known pronoun reference type for a reference stored in a database), an entity reference (or known entity reference type for an entity stored in a database), and/or an alternative reference (e.g., an alternative reference type, such as an unknown reference instance not stored in a database and/or or a textually inconsistent reference instance). In one or more embodiments, a reference instance may be linked to other references to form a “reference pair” (e.g., two linked reference instances) or a “reference group” (e.g., including more than two linked reference instances).

As further used herein, the term “entity” refers to a distinct and identifiable unit of information in a text (e.g., a genealogical-record text). In particular, an entity can refer to a person, organization, place, object, date, event, concept, and/or other real-world or abstract entity.

Furthermore, as used herein, the term “coreference match” refers to identification and linking of two or more reference instances that refer to the same entity (or a common or shared entity) within a text (e.g., a genealogical-record text) or across multiple texts. In some embodiments, a coreference match occurs when the coreference-determination system 100 determines, by utilization of one or more entity-matching LLMs and/or a non-entity-matching LLM, that two reference instances likely refer to the same entity. In some cases, a plurality of coreference matches can be linked together to generate a coreference cluster. For instance, as used herein, the term “coreference cluster” can refer to a set of two or more coreference matches that collectively refer to the same entity.

As used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, and Bayesian networks, among other possibilities.

Relatedly, as used herein, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative adversarial neural network. Upon training as described below, such a neural network may become a large language model that generates responses to prompts by interpreting prompt language, accessing additional data from content items, and executing functions indicated by prompts and/or content items.

Along these lines, as used herein, the term “large language model” (or “LLM”) refers to a set of one or more machine learning models trained to perform computer tasks to generate or identify computing code and/or data in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate or identify computing code and/or data based on various contextual data, including information from historical user-account behavior.

As used herein the term, “combined-LLM model” refers to a specialized model architecture (e.g., a hierarchical entity-matching architecture) that includes a set of multiple specialized LLMs, a multilingual encoder, a reference scorer, and/or other coreference-determination system 100 architecture. For instance, the combined-LLM model can include a plurality of candidate entity-matching LLMs (e.g., a mixture of experts or “MOE” and/or a non-entity-matching LLM). In the same or other embodiments, the combined-LLM model can also include a multilingual encoder, a reference scorer, a reference classifier (e.g., a classifier LLM), and/or a model-selection router. Indeed, the combined-LLM model In at least one embodiment, the combined-LLM model can be used to analyze text (e.g., a genealogical-record text) and/or reference-instance data and to determine whether different reference instances correspond to the same entity. Each LLM in the plurality of candidate entity-matching LLMs, which may each be referred to herein as an “entity-matching large language model” (or an “entity-matching LLM”), can be trained and/or fine-tuned to handle specific aspects of entity resolution (e.g., a process of identifying, disambiguating, scoring, and/or linking different references to the same entity) and/or coreference matching. For instance, each entity-matching LLM can perform aspects of entity resolution and/or coreference matching by leveraging contextual, linguistic, and/or semantic information (or data) within a given dataset (such as a given genealogical-record text) (or across datasets).

As also used herein, the term “pronoun-pronoun large language model” (or “pronoun-pronoun LLM”) refers to a specialized LLM designed to analyze and resolve relationships between pronoun references (e.g., known references that are pronouns) within a given text (e.g., a genealogical-record text). In particular, the pronoun-pronoun LLM can be an entity-matching LLM that focuses on identifying, disambiguating, and/or generating reference-pair scores (or reference-group scores) for reference pairs (or reference groups) involving two or more pronoun references in a text.

As additionally used herein, the term “entity-entity large language model” (or “entity-entity LLM”) refers to a specialized LLM designed to analyze and resolve relationships between entity references (e.g., known references that are non-pronouns) within a given text (e.g., a genealogical-record text). Specifically, the entity-entity LLM can be an entity-matching LLM that focuses on identifying, disambiguating, and/or generating reference-pair scores (or reference-group scores) for two or more entity references (e.g., an entity-entity reference pair) within a text.

As further used herein, the term “pronoun-entity large language model” (or “pronoun-entity LLM”) refers to a specialized LLM designed to analyze and resolve relationships between pronoun references and entity references within a given text (e.g., a genealogical-record text). In particular, the pronoun-entity LLM can be an entity-matching LLM that focuses on identifying, disambiguating, and/or generating reference-pair scores (or reference-group scores) for at least one pronoun reference and at least one entity reference (e.g., a pronoun-entity reference pair) within a text.

Moreover, as used herein the term “alternative-reference large language model” (or “alternative-reference LLM”) refers to a specialized LLM designed to analyze and resolve relationships involving at least one alternative reference. In particular, the alternative-reference LLM can handle complex, ambiguous, implicit, and/or unconventional reference-instance cases. For instance, the alternative-reference LLM can leverage contextual embeddings, similarity-based embeddings, and/or probabilistic modeling to identify, disambiguate, and/or generate reference-pair scores (or reference-group scores) for reference pairs (or reference groups) involving at least one alternative reference within a text. In one or more embodiments, the alternative-reference LLM can handle reference instances cases involving one or more reference instances that are not a pronoun reference or an entity reference. In the same or other embodiments, the alternative-reference LLM can analyze and resolve cases involving at least one reference instance that is an unknown reference (e.g., a new reference or unrecognized reference) and/or a text-inconsistency reference (e.g., a misspelled reference).

As used herein, the term “non-entity-matching large language model” or (“non-entity-matching LLM”) refers to a LLM not specifically tailored or tuned for determining coreferences in text bodies. In particular, the non-entity-matching LLM can be a general-purpose LLM and/or a shared LLM that is designed to analyze and evaluate all (or selected) reference pairs (or reference groups), regardless of the reference type associated with each reference instance in the reference pairs based on broad, generalized training.

Relatedly, as used herein, the term “reference-pair score” (or “reference-group score”) refers to a numerical value assigned to a reference pair (or a reference group) to quantify the likelihood that the reference instances therein refer to the same entity. In particular, an entity-matching LLM and/or a non-entity-matching LLM may generate a reference-pair score or reference-group score to be used in coreference resolution and/or in generating coreference matches.

As also used herein, the term “multilingual encoder” refers to a neural network-based model (as part of a combined-LLM model) designed to process a text (e.g., a genealogical-record text) and to encode the text into vector representations (or embeddings). In particular, the multilingual encoder can process a text, such as a genealogical-record text, that includes reference instances and generate vector representations (or embeddings) of the text across multiple languages. To elaborate, in some cases, the multilingual encoder is trained on multilingual datasets or a plurality of datasets corresponding to different languages, enabling it to understand and encode reference instances from diverse linguistic sources while preserving contextual meaning and syntactic relationships. In at least one embodiment, the multilingual encoder can be an LLM that is given multilingual capability by training the LLM on specific examples in a plurality of languages (e.g., using example data from a database, such as database 106 described below). The multilingual encoder may additionally or alternatively be trained and/or fine-tuned on open-source data. Further, in some embodiments, the multilingual encoder tokenizes a text (e.g., including the reference instances) and converts the tokens into vector representations that capture the reference instances, including semantic meaning and/or structural and contextual information, independent of language-specific variations. In the same or other embodiments, the multilingual encoder can send the vector representations to a reference scorer to identify and evaluate reference instances.

Along these lines, as used herein, the term “reference scorer” refers to a computational component responsible for determining and evaluating reference instances within a text (e.g., a genealogical-record text). In particular, the reference scorer can determine a likelihood that a portion (or segment) of a text is or contains a meaningful or significant mention that may require coreference resolution and/or coreference matching. For instance, the reference scorer can process encoded text representations or vector representations received from a multilingual encoder and assign confidence scores to portions (or segments) of the text.

Further, as used herein, the term “model-selection router” refers to a specialized computational component (as part of a combined-LLM model) for directing reference-instance data to an entity-matching LLM for analysis. Specifically, the model-selection router can generate reference pairs (or reference groups) and determine which reference pairs (or reference groups) should be analyzed together at a certain entity-matching LLM. For instance, the model-selection router may leverage multilingual heuristics and reference-instance data to determine which entity-matching LLM will analyze each reference pair (or reference group). In some cases, the multilingual heuristics may include language identification, syntactic structures, phonetic similarity, historical name variations, and/or domain specific entity-resolution rules.

Along these lines, as used herein, the term “reference-instance data” can refer to data associated with one or more reference instances (e.g., candidate reference instances, reference pairs, or reference groups), such as vector representations (e.g., of the reference instances and/or of the genealogical-record text), confidence scores, and/or metadata.

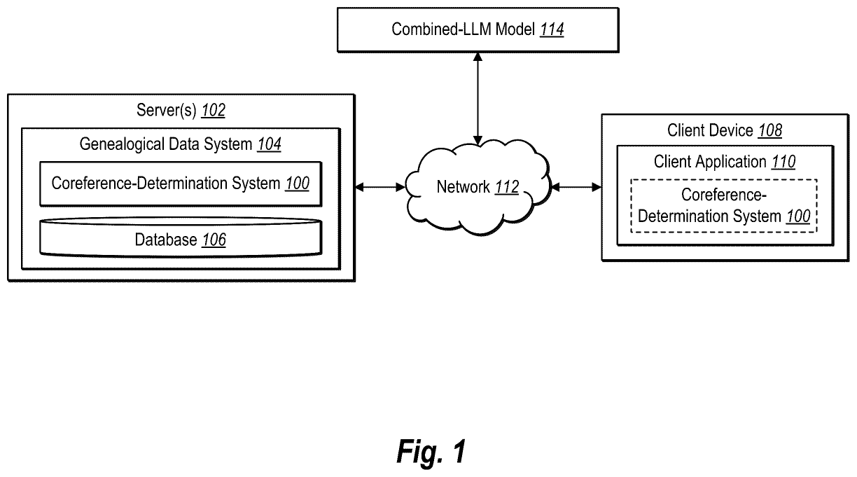

Additional detail regarding the coreference-determination system 100 will now be provided with reference to the figures. For example, FIG. 1 illustrates a schematic diagram of an example system environment for implementing the coreference-determination system 100 in accordance with one or more embodiments. An overview of the coreference-determination system 100 is described in relation to FIG. 1. Thereafter, a more detailed description of the components and processes of the coreference-determination system 100 is provided in relation to the subsequent figures.

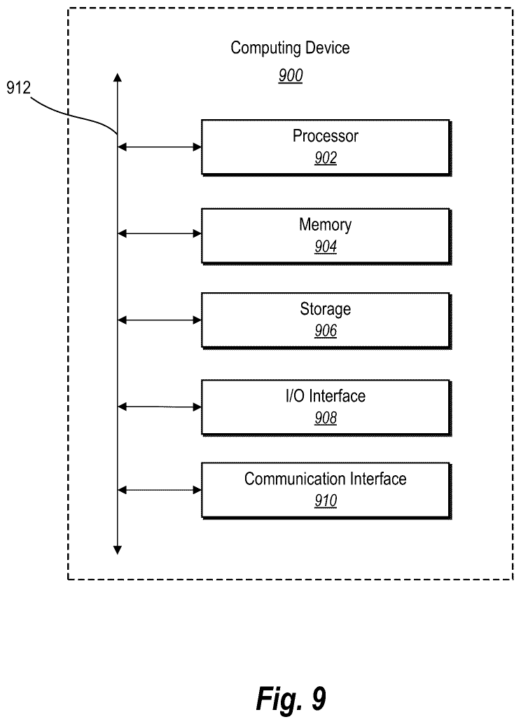

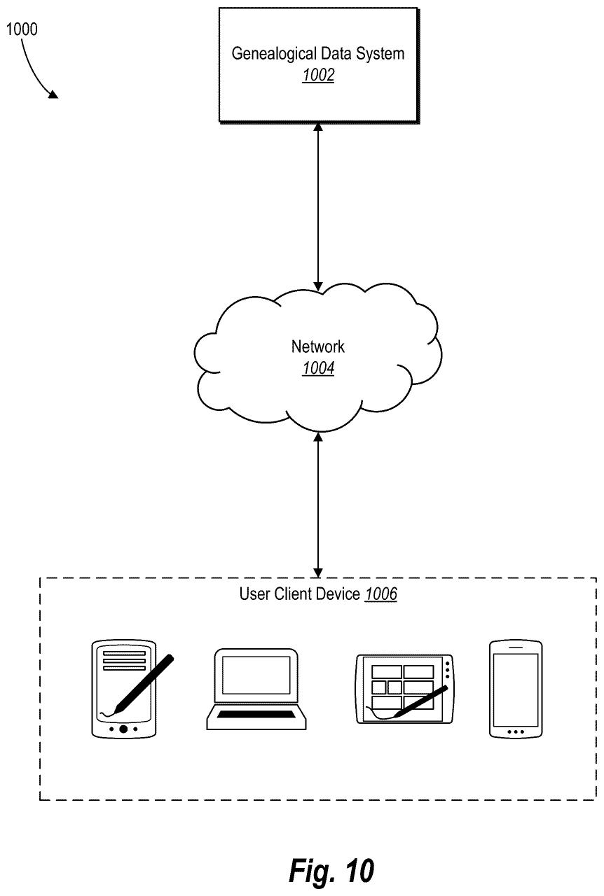

As shown, the environment includes server(s) 102, a client device 108, a database 106, a network 112, and a combined-LLM model 114. Each of the components of the environment can communicate via the network 112, and the network 112 may be any suitable network over which computing devices can communicate. Example networks are discussed in more detail below in relation to FIGS. 9-10.

As mentioned above, the example environment includes a client device 108. The client device 108 can be one of a variety of computing devices, including a smartphone, a tablet, a smart television, a desktop computer, a laptop computer, a virtual-reality device, an augmented-reality device, or another computing device as described in relation to FIGS. 9-10. The client device 108 can communicate with the server(s) 102 and/or the database 106 via the network 112. For example, the client device 108 can receive user input from respective users interacting with the client device 108 (e.g., via a client application 110) to, for instance, search for, identify, access, generate, modify, or share a genealogical record (e.g., a genealogical-record text), a reference instance (or reference group), a coreference match, and/or a coreference cluster via a graphical user interface of a genealogical data system 104. In addition, the coreference-determination system 100 on the server(s) 102 can receive information relating to various searches for, or interactions with, genealogical records and/or user-interface elements based on the input received by the client device 108.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 102. Based on instructions from the client application 110, the client device 108 can present or display information, including a user interface such as a genealogical-record search interface, a coreference-management interface, or some other graphical user interface, as described herein.

As illustrated in FIG. 1, the example environment also includes the server(s) 102. The server(s) 102 may generate, track, store, process, receive, and transmit electronic data, such as search requests, genealogical records, record queries, query results, reference instances (or reference pairs or reference groups), coreference matches, and/or coreference clusters. For example, the server(s) 102 may receive data from the client device 108 in the form of an indication of a selection to view a particular graphical user interface or to perform a search for a genealogical record. In addition, the server(s) 102 can transmit data to the client device 108 within a graphical user interface. Indeed, the server(s) 102 can communicate with the client device 108 to send and/or receive data via the network 112. In some implementations, the server(s) 102 comprise(s) a distributed server where the server(s) 102 include(s) a number of server devices distributed across the network 112 and located in different physical locations. The server(s) 102 can comprise one or more content servers, application servers, communication servers, web-hosting servers, machine learning servers, and other types of servers.

As shown in FIG. 1, the server(s) 102 can also include the coreference-determination system 100 as part of a genealogical data system 104. The genealogical data system 104 can communicate with the client device 108 to perform various functions associated with the client application 110 such as generating coreference matches and/or coreference clusters, managing user accounts, managing genealogical data, managing genealogical records, and/or facilitating user interaction with, and sharing of, genealogical records. Indeed, the genealogical data system 104 can include a network-based cloud-storage system to manage, store, and maintain reference instances, coreference matches and/or coreference clusters, and/or genealogical records, and genealogy trees related to user accounts. For instance, the genealogical data system 104 can utilize genealogical data across various content items and user accounts to generate and maintain a universal genealogy tree that reflects the relatedness or consanguinity between nodes corresponding to all user accounts and other individuals indicated by stored genealogical records, user-generated pedigrees, genetic-testing results, user-generated content, etc. In some embodiments, the coreference-determination system 100 and/or the genealogical data system 104 utilize the database 106 to store and access information such as genealogical records, genealogy trees, user account data, reference instances, coreference matches, coreference clusters, and/or other information.

As further illustrated in FIG. 1, the combined-LLM model 114 can interact with the network 112. In particular, the combined-LLM model 114 can leverage the network 112 to transmit and/or receive data to and from the server(s) 102 and/or the client device 108. For instance, the combined-LLM model 114 can transmit and/or receive data that includes vector representations (or embeddings), reference instances, reference-pair scores (or reference-group scores), coreference matches, and/or coreference clusters.

Although FIG. 1 depicts the coreference-determination system 100 located on the server(s) 102, in some implementations, the coreference-determination system 100 may be implemented by (e.g., located entirely or in part on) one or more other components of the environment. For example, the coreference-determination system 100 may be implemented in whole or in part by the client device 108. For example, the client device 108 and/or a third-party system can download all or part of the coreference-determination system 100 for implementation independent of, or together with, the server(s) 102.

In some implementations, though not illustrated in FIG. 1, the environment may have a different arrangement of components and/or may have a different number or set of components altogether. For example, the client device 108 may communicate directly with the coreference-determination system 100, bypassing the network 112. As another example, the environment may include multiple client devices, each associated with a different user account. In addition, the environment can include the database 106 located external to the server(s) 102 (e.g., in communication via the network 112) or located on the server(s) 102 and/or on the client device 108.

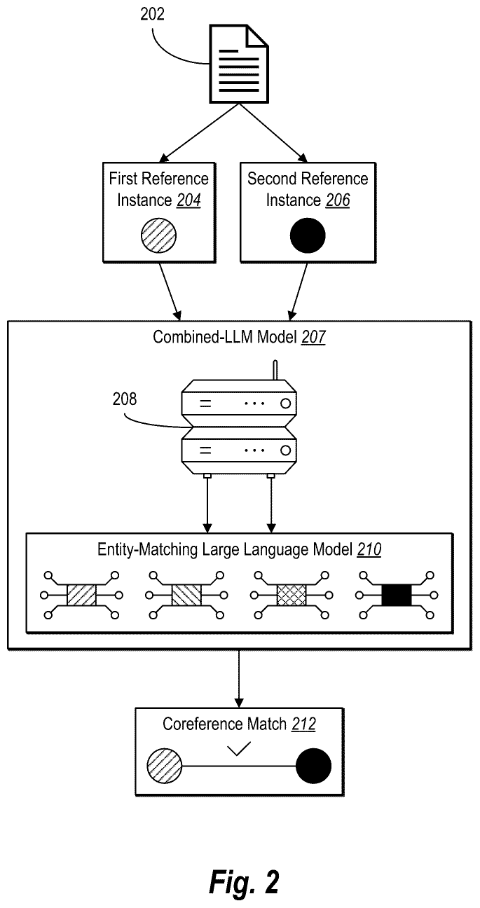

As expressed above, the coreference-determination system 100 can generate a coreference match for an entity in a genealogical-record text. In particular, the coreference-determination system 100 can utilize a combined-LLM model 114 to generate a coreference match for an entity indicated by a first reference instance and a second reference instance. FIG. 2 illustrates an example diagram of utilizing an entity-matching LLM to generate a coreference match for an entity in accordance with one or more embodiments. Additional detail regarding the various acts and processes introduced in relation to FIG. 2 is provided thereafter with reference to subsequent figures.

As illustrated in FIG. 2, the coreference-determination system 100 can identify and/or receive a genealogical-record text 202. In particular, the coreference-determination system 100 can use an entity-extraction model to process the genealogical-record text 202. Upon processing the genealogical-record text 202, the coreference-determination system 100 can use the entity-extraction model to detect and/or extract one or more reference instances from the genealogical-record text 202. In at least one embodiment, the coreference-determination system 100 may utilize a combined-LLM model (e.g., combined-LLM model 207) to generate one or more coreference matches (e.g., coreference match 212) and/or one or more coreference clusters. In some instances, the coreference-determination system 100 provides the one more coreference matches and/or the one or more coreference clusters and (at least in some cases) the genealogical-record text 202 to a relationship-detection model. Based on this, the coreference-determination system 100 may use the relationship-detection model to determine (or detect) relationships between various coreference matches and/or coreference clusters found within the genealogical-record text 202 (and/or within other genealgocial-record texts).

Further, as additionally illustrated in FIG. 2, the coreference-determination system 100 can identify the genealogical record text 202 by searching a database (e.g., the database 106). In the same or other embodiments, the coreference-determination system 100 can receive the genealogical-record text 202 based on an upload, a transfer, or any other method. In one or more embodiments, the genealogical-record text 202 can be, in whole or in part, associated with one or more of a plurality of languages. In some embodiments, the coreference-determination system 100 can identify and/or receive a plurality of genealogical-record texts, and the plurality of genealogical-record texts may each be, in whole or in part, associated with one or more of a plurality of languages.

As also illustrated in FIG. 2, the coreference-determination system 100 detects, from the genealogical-record text 202, a first reference instance 204 corresponding to an entity and a second reference instance 206 corresponding to an entity. Specifically, the coreference-determination system 100 can analyze the genealogical-record text 202 to detect the first reference instance 204 and the second reference instance 206. In some cases, the first reference instance 204 and/or the second reference instance 206 each correspond to a particular reference type of a plurality of reference types. For example, the first reference instance 204 and/or the second reference instance 206 may be determined to correspond to a pronoun reference (or pronoun reference type), an entity reference (or entity reference type), and/or an alternative reference (or alternative reference type). In one or more embodiments, the coreference-determination system 100 detects, from the genealogical-record text 202, one or more additional reference instances corresponding to the entity and/or to one or more additional entities.

As shown in FIG. 2, the coreference-determination system 100 can use a combined-LLM Model 207. For example, the coreference-determination system 100 can utilize specialized architecture to generate a coreference match. In at least one embodiment, the combined-LLM model 207 includes a model-selection router 208 and a plurality of candidate entity-matching LLMs. In the same or other embodiments, the combined-LLM model 207 includes one or more additional or alternative architecture, such as a non-entity-matching LLM, a multilingual encoder, a reference scorer, and/or a reference classifier (e.g., a classifier LLM).

As additionally illustrated in FIG. 2, the coreference-determination system 100 uses the model-selection router 208 to determine an entity-matching LLM 210. In particular, the model-selection router 208 receives data associated with the first reference instance 204 and the second reference instance 206. In some embodiments, the model-selection router 208 can process the data associated with the first reference instance 204 and the second reference instance 206 and can dynamically direct or route (and/or provide) the data to a specific (and/or appropriate) entity-matching LLM 210 from among those in the combined-LLM model 207 for analysis. In some instances, the coreference-determination system 100 can select the entity-matching LLM 210 from among the plurality of candidate entity-matching LLMs included in the combined-LLM model 207 based on detected reference types. To elaborate, the model-selection router 208 can determine the entity-matching LLM 210 (or the plurality of entity-matching LLMs) based on determining that the first reference instance 204 and the second reference instance 206 each correspond to the same (or a shared) reference type which is associated with the determined entity-matching LLM 210.

As further illustrated in FIG. 2, the coreference-determination system 100 utilizes an entity-matching LLM 210 (or a plurality of entity-matching LLMs) from among the plurality of candidate entity-matching LLMs to generate a coreference match 212. Specifically, upon receiving the data associated with the first reference instance 204 and the second reference instance 206, the determined entity-matching LLM 210 can determine whether the first reference instance 204 and the second reference instance 206 both refer to the same entity. As an example, the entity-matching LLM 210 can generate a confidence score indicating a likelihood as to whether the reference instances 204, 206 refer to the same entity. In the same or other embodiments, the coreference-determination system 100 also utilizes a non-entity-matching LLM (e.g., in addition to the entity-matching LLM 210) to generate the coreference match 212.

As shown in FIG. 2, the coreference-determination system 100 generates the coreference match 212. In particular, the coreference-determination system 100 can generate the coreference match 212 in response to determining that the reference instances 204, 206 likely refer to the same entity (e.g., with at least a threshold confidence score or probability). For instance, the coreference-determination system 100 generate the coreference match 212 by linking or correlating the first reference instance 204 and the second reference instance 206.

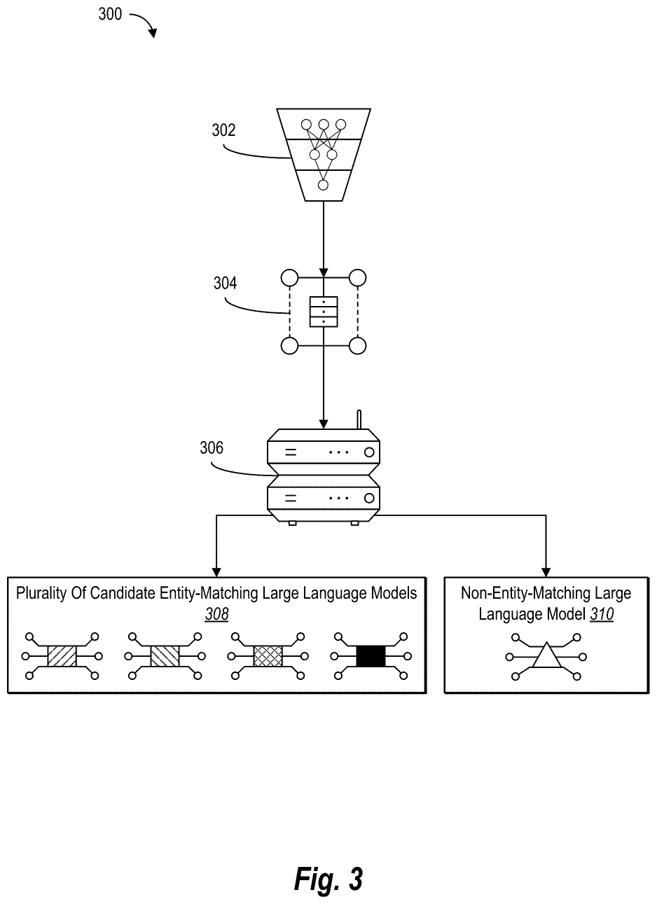

As expressed above, in some embodiments, the coreference-determination system 100 utilizes an entity-matching LLM and a non-entity-matching LLM to generate a coreference match. In particular, the coreference-determination system 100 can utilize a hierarchical entity-matching architecture in the form of a combined-LLM model—including a multilingual encoder, a reference scorer, a reference classifier, a model-selection router, a plurality of candidate entity-matching LLMs, and/or a non-entity-matching LLM—to generate the coreference match. FIG. 3 illustrates an example diagram of the hierarchical entity-matching architecture (or the combined-LLM model) utilized by the coreference-determination system 100 in accordance with one or more embodiments.

As shown in FIG. 3, the coreference-determination system 100 utilizes a combined-LLM model 300 to generate a coreference match. In particular, the combined-LLM model 300 can include at least one of each of the following: a multilingual encoder (e.g., multilingual encoder 302), a reference scorer (e.g., reference scorer 304), a reference classifier, and/or a model-selection router (e.g., model-selection router 306). In the same or other embodiments, the combined-LLM model 300 also includes a plurality of candidate entity-matching LLMs 308 and/or at least one non-entity-matching LLM (e.g., non-entity-matching LLM 310).

As illustrated in FIG. 3, the coreference-determination system 100 uses a multilingual encoder 302 to process a genealogical-record text and to encode the text into vector representations (or embeddings) within an embedding space. In particular, the multilingual encoder 302 can process the genealogical-record text (which can be associated, in whole or in part, with one or more of a plurality of languages, such as a non-English text) to tokenize the genealogical-record text. Upon tokenizing the genealogical-record text, the multilingual encoder 302 can convert the tokens into numerical vector representations that can capture the reference instances, semantic meaning, and/or structural and contextual information of the genealogical-record text. In some embodiments, in response to generating the vector representations, the multilingual encoder 302 can send (or provide) the vector representations to a reference scorer 304.

As also illustrated in FIG. 3, the coreference-determination system 100 can use the reference scorer 304 to detect (or identify) and evaluate reference instances (or likely reference instances). Specifically, upon receiving the vector representations from the multilingual encoder 302, the reference scorer 304 can determine a likelihood that a portion (or segment), such as a string of characters or tokens, of the genealogical-record text is or contains a meaningful or significant mention or reference instance that may require coreference resolution and/or coreference matching. For instance, the reference scorer 304 can process the vector representations of the tokenized genealogical-record text and identify (or detect) candidate reference instances by assigning one or more confidence scores to portions (or segments) of the genealogical-record text. In some embodiments, the one or more confidence scores reflect a probability that a candidate reference instance identified from the tokenized genealogical-record text is a meaningful or significant mention in the text and should be further analyzed for coreference resolution and/or coreference matching. In the same or other embodiments, the reference scorer 304 sends (or provides) the identified candidate reference instances and reference-instance data—which can include the vector representations (e.g., of the reference instances and/or of the genealogical-record text), the confidence scores, and/or metadata associated with the candidate reference instances—to a model-selection router 306.

In one or more embodiments, the coreference-determination system 100 determines a reference type for each candidate reference instance. In particular, using rule-based classification and/or the reference-instance data, the coreference-determination system 100 can classify each candidate reference instance to a reference type. For instance, the coreference-determination system 100 may classify a candidate reference instance as a pronoun reference, an entity reference, and/or an alternative reference. In some embodiments, the coreference-determination system 100 can determine a reference type for each candidate reference instance using the reference scorer 304 based on the candidate reference instances and the reference-instance data prior to sending (or providing) the candidate reference instances and the reference-instance data to the model-selection router 306. In the same or other embodiments, the coreference-determination system 100 can determine a reference type for each candidate reference instance using a reference classifier (e.g., a classifier LLM) trained on reference-type-specific examples, including pronoun-reference examples, entity-reference examples, and/or alternative-reference examples. In some cases, the robust examples can include text and/or indications of correctly and/or incorrectly determined coreference matches.

As additionally illustrated in FIG. 3, the coreference-determination system 100 can use the model-selection router 306 to direct (or provide) the candidate reference instances and/or the reference-instance data to an entity-matching LLM. In particular, the model-selection router 306 can receive and process the candidate reference instances and/or the reference-instance data. Upon processing the candidate reference instances and/or the reference-instance data, the model-selection router 306 can determine and generate reference pairs (or reference groups) from the candidate reference instances to send to an entity-matching LLM. Specifically, the model-selection router 306 can determine which pairs (or chains) of reference instances should be analyzed together. For example, the model-selection router 306 leverages multilingual heuristics and one or more reference-pair strategies to generate the reference pairs (or reference groups). To elaborate, the one or more reference-pair strategies can include proximity-based pairing, linguistic rules and/or syntactic structures, and/or lexical and semantic-similarity matching. In some embodiments, the model-selection router 306 generates reference pairs (or reference groups) based on various possible combinations of reference instances, irrespective of reference pair strategies.

As just mentioned, the model-selection router 306 may leverage proximity-based pairing to determine and generate reference pairs (or reference groups). In particular, the model-selection router 306 can use proximity-based pairing to pair reference instances that appear close together in the text. In some cases, the coreference-determination system 100 (using the model-selection router 306) determines a pixel distance, a number of characters, a number of lines, a number of sentences, a number of paragraphs, and/or a number of tokens separating reference instances. The coreference-determination system 100 can further compare these distance metrics to one or more thresholds defining levels of proximity. In these or other cases, the coreference-determination system 100 determines a number of topic changes separating reference instances to determine a proximity. For example, consider the following: “Marie Curie discovered radium. She revolutionized chemistry.” Here, the proximity-based pairing could include “Marie Curie” and “She” based on comparing the separation of pixels, characters, lines, sentences, paragraphs, and/or topics between the two reference instances.

As also mentioned above, the model-selection router 306 may leverage linguistic rules and/or syntactic structures to determine and generate reference pairs (or reference groups). Specifically, the model-selection router 306 may use linguistic rules and/or syntactic structures—such as gender, number, and animacy agreement—to pair references and/or to eliminate improbable (or impossible) pairings. For instance, consider the following: “The dog barked, and they ran away.” The model-selection router 306 may determine that “The dog” and “they” are unlikely to both refer to the dog based on syntactic rules indicating a singular dog and a plural “they.” Accordingly, the model-selection router 306 may refrain from generating and passing “The dog” and “they” as a reference pair to an entity-matching LLM.

As further mentioned above, the model-selection router 306 may leverage lexical and semantic-similarity matching to determine and generate reference pairs (or reference groups) from the reference instances. In particular, the model-selection router 306 can compute cosine similarity between reference-instance embeddings. Indeed, the multilingual encoder 302 can encode reference-instance embeddings, and the model-selection router 306 can determine cosine similarities (and/or distances in embedding space) between the reference-instance embeddings. In some embodiments, if two reference instances have high semantic similarity (or a close distance), the model-selection router 306 determines that both are likely to be coreferential and will pair them together for further analysis by a downstream entity-matching LLM. As an example, the model-selection router 306 can determine “United States” and “US” to have high embedding similarity based on comparing their embeddings in the embedding space.

As shown in FIG. 3, the coreference-determination system 100 directs (or routes) the reference pairs (or reference groups) to a plurality of candidate entity-matching LLMs 308. In particular, the coreference-determination system 100 can use the model-selection router 306 to direct a reference pair (or reference group) (and, in some cases, associated reference-instance data) to an entity-matching LLM of or within the plurality of candidate entity-matching LLMs 308 based on the determined reference types of the reference instances in a reference pair (or reference group). In some embodiments, the plurality of candidate entity-matching LLMs 308 may generate and provide feedback for finetuning the model-selection router 306 (e.g., to refine future reference-pair selections). For instance, the plurality of candidate entity-matching LLMs 308 can generate feedback in the form of positive and/or negative indications of correct and/or incorrect selections and can provide the feedback to the model-selection router 306 to adjust its internal weights and parameters governing routing.

As further shown in FIG. 3, the coreference-determination system 100 directs (or routes or provides) the reference pairs (or reference groups) and associated reference-instance data to a non-entity-matching LLM 310. In some embodiments, the model-selection router 306 directs reference pairs (or reference groups) to the non-entity-matching LLM 310 in addition to an entity-matching LLM of the plurality of candidate entity-matching LLMs 308. For example, the model-selection router 306 may direct reference pairs to the non-entity-matching LLM 310 regardless of the reference types associated with each reference pair. In the same or alternative embodiments, the model-selection router 306 may determine to not direct select or all reference pairs (or reference groups) to the non-entity-matching LLM 310, instead opting to only direct such to the plurality of candidate entity-matching LLMs 308. In at least one implementation, the coreference-determination system 100 utilizes the non-entity-matching LLM 310 to analyze and evaluate reference pairs (or reference groups), such as by scoring the reference pairs (or reference groups) and/or by generating confidence scores for the reference pairs (or reference groups) according to the general, non-reference-type-specific training and tuning of the non-entity-matching LLM 310.

In one or more embodiments, the coreference-determination system 100 utilizes an entity-matching LLM in the plurality of candidate entity-matching LLMs 308 and/or the non-entity-matching LLM 310 to generate a coreference match. In particular, upon receiving a reference pair (or reference group), at least one entity-matching LLM and the non-entity-matching LLM 310 can generate confidence scores that indicate a likelihood that the reference instances in the reference pair (or reference group) refer to the same entity. As an example, an entity-matching LLM can generate a first confidence score and the non-entity-matching LLM 310 can generate a second confidence score. In at least one embodiment, the coreference-determination system 100 combines the confidence scores (e.g., the first confidence score and the second confidence score) to generate the coreference match (e.g., upon determining that the combined confidence score satisfies a threshold).

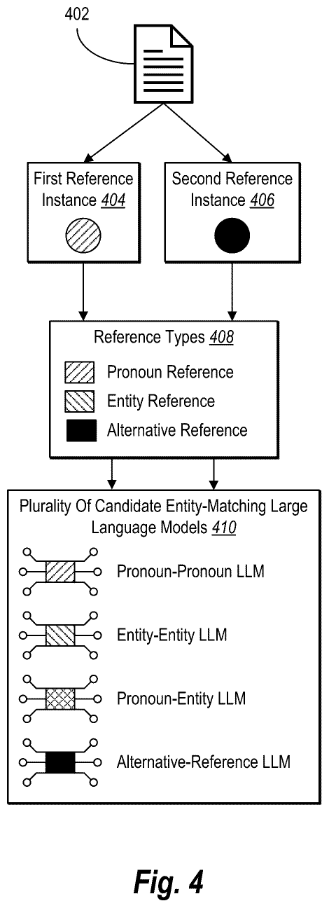

As expressed above, the coreference-determination system 100 can determine an entity-matching LLM of a plurality of entity-matching LLMs 308 to analyze a given reference pair. For instance, the coreference-determination system 100 can determine that the entity-matching LLM may be appropriate to analyze the reference pair based on a reference type for each of the reference instances in the reference pair. FIG. 4 illustrates an example diagram of selecting an entity-matching LLM based on determining a reference type for each reference instance in a reference pair in accordance with one or more embodiments.

As illustrated in FIG. 4, the coreference-determination system 100 detects reference instances from a genealogical-record text 402. For instance, the coreference-determination system 100 detects a first reference instance 404 and a second reference instance 406 in the genealogical-record text 402 as described above.

As also illustrated in FIG. 4, the coreference-determination system 100 can determine reference types 408 for the detected reference instances. Specifically, upon using a multilingual encoder and a reference scorer (as outlined above), the coreference-determination system 100 can use rule-based classification and/or reference-instance data to determine a reference type for each reference instance (e.g., the first reference instance 404 and the second reference instance 406). In some embodiments, the coreference-determination system 100 can determine the reference types 408 using the reference scorer and/or using a reference classifier (e.g., a classifier LLM), as described in greater detail above. To elaborate, the coreference-determination system 100 can apply a deterministic rule-based function that classifies each reference instance 404, 406 based on, for example, linguistic heuristics. In some embodiments, the deterministic rule-based function checks whether a reference instance is: (1) a noun or proper noun (e.g., based on named-entity recognition or on other recognition techniques, such as capitalization); (2) contains descriptive modifiers (e.g., “the scientist”); (3) an abbreviation or an acronym (e.g., “USA” or “NASA”); (4) an alias; (5) a title; (6) a descriptive phrase; (7) a pronoun; or (8) a combination of words indicating a person, place, thing, or concept.

As additionally illustrated in FIG. 4, the coreference-determination system 100 can determine that a reference instance corresponds to a specific reference type of the reference types 408. In particular, based on the deterministic rule-based function classification (according to the linguistic heuristics described above), the coreference-determination system 100 can determine that a reference instance is pronoun reference type, an entity reference type, and/or an alternative reference type. For instance, the coreference-determination system 100 may determine that the first reference instance 404 is a pronoun reference. In one or more embodiments, a pronoun reference corresponds to a known and/or textually consistent (e.g., correctly spelled) pronoun associated with a person, place, or thing. For example, a pronoun reference may correspond to reflexive pronouns (e.g., myself, yourself, themselves), indefinite pronouns (e.g., someone or something), possessive pronouns (e.g., mine or yours), relative pronouns (e.g., which, that, who, or whom), personal pronouns (e.g., I, you, or they), demonstrative pronouns that demonstrate something from a previous sentence, interrogative pronouns that replace an unknown (e.g., who or what), and/or reciprocal pronouns that indicate mutual relationships (e.g., each other or one another).

As just mentioned, the coreference-determination system 100 can determine that a reference instance is an entity reference. For instance, the coreference-determination system 100 may determine that the second reference instance 406 is an entity reference. In some embodiments, an entity reference corresponds to a known and/or textually consistent (e.g., correctly spelled) entity. In the same or other embodiments, an entity reference corresponds to a named entity—such as a proper noun or other noun—and/or an acronym for a named entity. As an example, an entity reference may correspond to “John Smith,” “the company,” or “USA.”

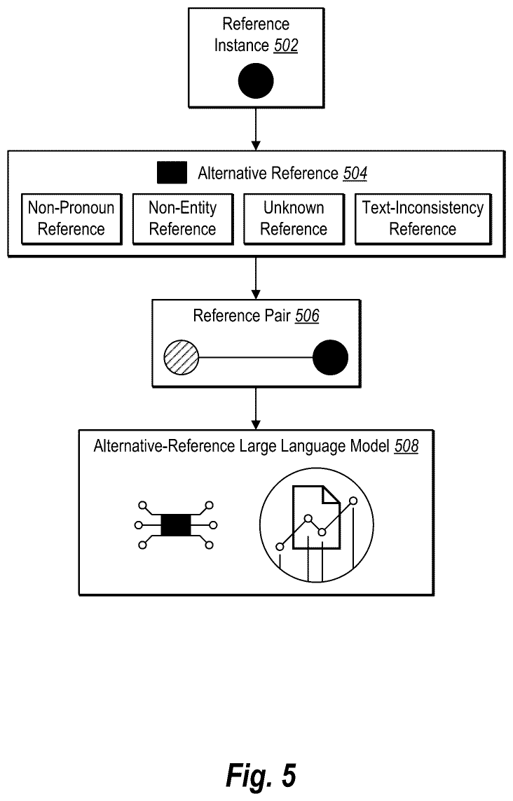

As also mentioned above, the coreference-determination system 100 can determine that a reference instance is an alternative reference (or a reference instance that is neither an entity reference nor a pronoun reference). For instance, the coreference-determination system 100 may generate a confidence score for the first reference instance 404 and/or a confidence score for the second reference instance 406. Upon generating the confidence scores, the coreference-determination system 100 may determine that the confidence score for the first reference instance 404 and/or confidence score for the second reference instance 406 do not satisfy thresholds for indicating an entity reference or a pronoun reference. The coreference-determination system 100 can thus determine that the first reference instance 404 and/or the second reference instance 406 is an alternative reference. In some cases, the coreference-determination system 100 determines that a confidence score for the first reference instance 404 and/or the second reference instance 406 satisfies a threshold for indicating the alternative reference type. An alternative reference can correspond to a reference that is not a pronoun reference or an entity reference, but which nevertheless refers to an entity with particular verbiage or phrasing. An alternative reference may include many sub-types or sub-categories. For instance, an alternative reference may indicate an unknown reference (e.g., a novel reference or an unrecognized reference) and/or a text-inconsistency reference (e.g., a misspelled reference). Additional detail pertaining to alternative references is included below with reference to FIG. 5.

As further illustrated in FIG. 4, the coreference-determination system 100 determines an entity-matching LLM from the plurality of candidate entity-matching LLMs 410 to analyze a given reference pair (or a reference group), e.g. reference instances 404, 406. In particular, as described above, the coreference-determination system 100 can generate a reference pair (or a reference group of more than two reference instances). For example, the coreference-determination system 100 can generate a reference pair that includes the first reference instance 404 and the second reference instance 406, where the first reference instance 404 and the second reference instance 406 can be the same or different reference types. Upon doing so, the coreference-determination system 100 can determine an entity-matching LLM of the plurality of candidate entity-matching LLMs 410 to analyze the reference pair.

To elaborate, the entity-matching LLMs in the plurality of candidate entity-matching LLMs 410 can include a pronoun-pronoun LLM, an entity-entity LLM, a pronoun-entity LLM, and/or an alternative-reference LLM. The plurality of candidate entity-matching LLMs 410 can also include one or more additional or alternative entity-matching LLMs (e.g., a similarity entity-matching LLM) to further improve coreference matches. In at least one embodiment, two or more of the plurality of candidate entity-matching LLMs 410 can operate simultaneously or sequentially. Further, in some cases, the coreference-determination system 100 dynamically selects a relevant entity-matching LLM—or combines multiple entity-matching LLMs—to generate (or contribute to generating) a coreference match and/or a coreference cluster.

In one or more embodiments, the coreference-determination system 100 directs (or routes or provides) a reference pair (or reference group) to an entity-matching LLM (as described above). Specifically, the coreference-determination system 100 can direct the reference pair to an entity-matching LLM based on the determined reference types of the reference instances in the reference pair. As an example, in the reference pair that includes the first reference instance 404 and the second reference instance 406, if the first reference instance 404 corresponds to an entity reference and the second reference instance 406 corresponds to an entity reference, the coreference-determination system 100 may direct the reference pair to an entity-entity LLM. As another example, if the first reference instance 404 corresponds to a pronoun reference and the second reference instance 406 corresponds to an alternative reference, the coreference-determination system 100 may direct the reference pair to alternative-reference LLM.

In the same or other embodiments, an entity-matching LLM within the plurality of candidate entity-matching LLMs 410 acts as a gender-prediction model. That is, the pronoun-pronoun LLM, the entity-entity LLM, the pronoun-entity LLM, and/or the alternative-reference LLM may act as a gender-prediction model. To elaborate, a gender-prediction model can predict (or determine and/or classify) a gender for a particular entity based on coreference matches, coreference clusters, reference instances, and/or contextual data associated with the genealogical-record text 402. For instance, an entity-matching LLM may act as a gender-prediction model to predict (or determine and/or classify) a gender associated with one or more reference instances based on a coreference match and/or a coreference cluster. As an example, consider the following: “Mr. Charles went to the store so he could go shopping for his groceries. While there, Charles met Mr. Chuck.” Here, a gender-prediction model may predict (or determine and/or classify) that the gender associated with a “Charles” entity coreference cluster (e.g., including “Mr. Charles,” “he,” “his,” and “Charles”) is male. In making this prediction, the gender-prediction model may consider factors, such as the prefix “Mr.” (which corresponds to a male prefix), the pronouns “he” and “his” (which correspond to male pronouns, the name “Charles” (which often is associated with the male gender), and/or various contextual cues within the text. In the same or other embodiments, a gender-prediction model may be a separate model that is distinct from an entity-matching LLM within the plurality of candidate entity-matching LLMs 410. Further, in some embodiments, the coreference-determination system 100 may also train a gender-prediction model based on coreference matches and/or coreference clusters and predicted (or determined and/or classified) genders for the coreference matches and/or the coreference clusters.

As expressed above, the coreference-determination system 100 may determine that a reference pair (or reference group) should be analyzed by an alternative-reference LLM. Specifically, based on determining that one or more reference instances in a reference pair (or reference group) correspond to an alternative reference, the coreference-determination system 100 can direct the reference pair (or reference group) to an alternative-reference LLM for analysis. FIG. 5 illustrates an example diagram of directing a reference pair to an alternative-reference large language model in accordance with one or more embodiments.

As illustrated in FIG. 5, the coreference-determination system 100 determines that a reference instance 502 is an alternative reference 504 (or an alternative reference type). In particular, the coreference-determination system 100 can determine that the reference instance 502 is an alternative reference 504 by determining that the reference instance 502 corresponds to a reference that is not a pronoun reference (i.e., a non-pronoun reference) or an entity reference (i.e., a non-entity reference), but which nevertheless refers to an entity with particular verbiage or phrasing. For example, the coreference-determination system 100 can determine that the reference instance 502 may correspond to an indirect reference, an implicit reference (e.g., a zero-anaphora), an appositive reference (or phrase), and/or an event reference or abstract reference. In the same or other embodiments, the coreference-determination system 100 determines that the reference instance 502 is an alternative reference 504 by using an LLM trained on robust examples, including on alternative reference 504 sub-type (and/or sub-category) examples. In some cases, the robust examples include text for each alternative reference 504 sub-type (and/or sub-category) and/or indications of correct and/or incorrect coreference matches.

In one or more embodiments, an alternative reference 504 includes many sub-types or sub-categories. For instance, an alternative reference may indicate an unknown reference (e.g., a novel reference or an unrecognized reference) and/or a text-inconsistency reference (e.g., a misspelled or otherwise incorrect reference). For example, an unknown reference can correspond to a pronoun usage that is novel, uncommon, and/or not typically associated with an entity (e.g., “John Smith” and “she”). Further, in some cases, a text-inconsistency reference can include misspelled reference, such as “hee” or “Johhn Smth.”

As also illustrated in FIG. 5, the coreference-determination system 100 can generate a reference pair 506 (or a reference group). For instance, the coreference-determination system 100 can generate the reference pair 506 by pairing (or combining) the reference instance 502 with one or more other reference instances. For example, the coreference-determination system 100 can generate the reference pair 506 as described in greater detail above (e.g., in relation to FIG. 4).

As further illustrated in FIG. 5, the coreference-determination system 100 can direct (or route or provide) the reference pair 506 to an alternative-reference LLM 508. In particular, the coreference-determination system 100 can direct the reference pair 506 to the alternative-reference LLM 508 based on determining that one or more of the reference instances in the reference pair 506 correspond to an alternative reference 504. For example, the coreference-determination system 100 directs the reference pair 506 to the alternative-reference LLM 508 based on determining that the reference instance 502 corresponds to an alternative reference 504. In one or more embodiments, the alternative-reference LLM 508 functions to handle complex, ambiguous, implicit, and/or unconventional reference instance cases. For instance, the alternative-reference LLM 508 may assess reference pairs (or reference groups) that do not have clear lexical or grammatical alignment.

In one or more embodiments, the alternative-reference LLM 508 can analyze reference-instance data and/or genealogical-record text data associated with the reference pair 506. Based on this analysis, the alternative-reference LLM 508 can use one or more methods to determine if the reference instances in the reference pair 506 refer to the same entity. For instance, the alternative-reference LLM 508 can leverage contextual embeddings, similarity-based embeddings, and/or probabilistic modeling to generate reference-pair scores (or reference-group scores) for reference pairs (or reference groups) involving at least one alternative reference within a text such as a genealogical-record text.

As mentioned above, the coreference-determination system 100 can determine that the reference instance 502 may correspond to an indirect reference. Accordingly, the alternative-reference LLM 508 may generate a reference-pair score that quantifies the likelihood that the reference instance 502 and the other reference in the reference pair 506 refer (or do not refer) to the same entity. For example, consider the following: “I bought a book. The cover is beautiful.” In this example, the alternative-reference LLM 508 may determine that “cover” and “book” likely refer to the same entity.

As also mentioned above, the coreference-determination system 100 can determine that the reference instance 502 may correspond to an implicit reference, such as a zero-anaphora. Consequently, the alternative-reference LLM 508 may generate a reference-pair score that quantifies the likelihood that the reference instance 502 and the other reference in the reference pair 506 refer (or do not refer) to the same entity. As an example, consider the following: “Jonn went to the store. Bought some milk.” In some languages (e.g., Japanese, Chinese, and Spanish), pronouns are often omitted when they can be inferred. From the example, although the second sentence omits the subject, the alternative-reference LLM 508 may determine that that the second sentence is likely to be implicitly referring to “John” and thus the reference instances should be joined as a reference pair.

As additionally mentioned above, the coreference-determination system 100 can determine that the reference instance 502 may correspond to an appositive reference. In some cases, an appositive reference can refer to a restatement, a word, or a phrase that provides more information about a noun. Accordingly, the alternative-reference LLM 508 may generate a reference-pair score that quantifies the likelihood that the reference instance 502 and the other reference in the reference pair 506 refer (or do not refer) to the same entity. For example, consider the following: “Marie Curie, the famous scientist, discovered radioactivity.” In this example, the alternative-reference LLM 508 may determine that “Marie Curie” is likely to be indirectly linked to “the famous scientist” and thus the reference instances should be joined as a reference pair.

As further mentioned above, the coreference-determination system 100 can determine that the reference instance 502 may correspond to an event reference or abstract reference. In some cases, an event reference or abstract reference can include instances where, instead of referring to a noun, a reference instance (e.g., a pronoun) refers to an entire event or concept. Consequently, the alternative-reference LLM 508 may generate a reference-pair score that quantifies the likelihood that the reference instance 502 and the other reference in the reference pair 506 refer (or do not refer) to the same entity. For example, consider the following: “The company announced layoffs. This caused concern among employees.” In this example, the alternative-reference LLM 508 can determine that the antecedent of “This” likely refers to the event of “The company announc[ing] layoffs” and thus the reference instances should be joined as a reference pair.

In the same or other embodiments, the alternative-reference LLM 508 functions to handle additional or alternative complex, ambiguous, implicit, and/or unconventional reference instance cases. For example, the alternative-reference LLM 508 can deal with reference pairs involving one or more reference instances that correspond to an unknown reference (e.g., a novel reference or an unrecognized reference) and/or a text-inconsistency reference (e.g., a misspelled reference). Specifically, in some cases, the alternative-reference LLM 508 analyzes the reference-instance data and/or genealogical-record text data associated with a reference pair (or reference group) (e.g., reference pair 506). Based on this analysis, the alternative-reference LLM 508 can leverage contextual embeddings, similarity-based embeddings, and/or probabilistic modeling to generate reference-pair scores (or reference-group scores) for the reference pair (or reference group), as described above.

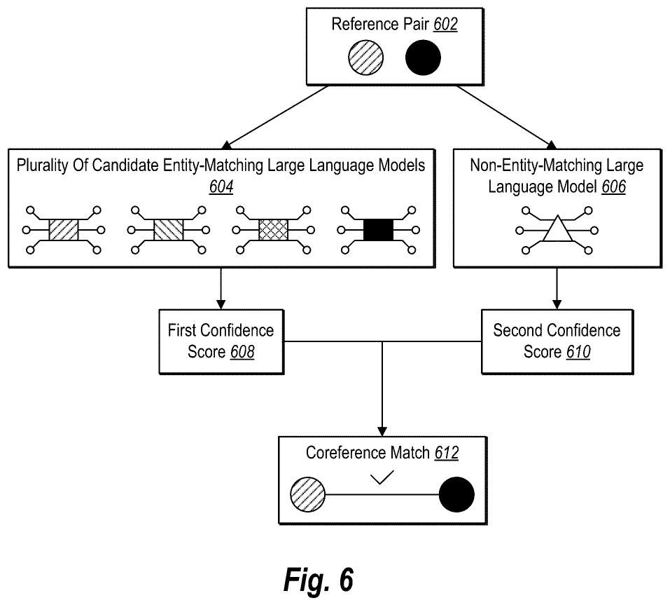

As expressed above, the coreference-determination system 100 can generate a coreference match between two or more reference instances. In particular, the coreference-determination system 100 can use a combined-LLM model, including a plurality of candidate entity-matching LLMs and a non-entity-matching LLM, to generate the coreference match. FIG. 6 illustrates an example diagram of generating a coreference match for an entity by utilizing the plurality of candidate entity-matching LLMs and the non-entity-matching LLM in accordance with one or more embodiments.

As illustrated in FIG. 6, the coreference-determination system 100 can generate a reference pair 602. In particular, the coreference-determination system 100 can generate the reference pair 602 as described in greater detail above.

As also illustrated in FIG. 6, the coreference-determination system 100 can direct (or route or provide) the reference pair 602 to a plurality of candidate entity-matching LLMs 604. In particular, the coreference-determination system 100 can direct the reference pair 602 to one or more entity-matching LLMs in the plurality of candidate entity-matching LLMs 604 as described in greater detail above. In the same or other embodiments, each entity-matching LLM in the plurality of candidate entity-matching LLMs 604 can be trained and/or fine-tuned to handle specific aspects of entity resolution (e.g., a process of identifying, disambiguating, and/or linking different references to the same entity) and/or coreference matching. For instance, each entity-matching LLM can perform aspects of entity resolution and/or coreference matching by leveraging (e.g., from reference-instance data) contextual, linguistic, and/or semantic information (or data) within a given dataset (or across datasets). In some embodiments, the plurality of candidate entity-matching LLMs 604 includes a pronoun-pronoun LLM, an entity-entity LLM, a pronoun-entity LLM, and/or an alternative-reference LLM.

As just mentioned, the plurality of candidate entity-matching LLMs 604 can include a pronoun-pronoun LLM. In particular, the pronoun-pronoun LLM can focus on identifying, disambiguating, and/or generating reference-pair scores (or reference-group scores) for reference pairs (or reference groups) involving two or more pronoun references within a text. For instance, the pronoun-pronoun LLM leverages contextual embeddings, syntactic analysis, and/or linguistic rules to determine a likelihood that pronoun references (e.g., a pronoun-pronoun reference pair) refer to the same entity. In some embodiments, the pronoun-pronoun LLM can generate a reference-pair score between pronoun references based on gender, number, and/or animacy agreement. In the same or other embodiments, the pronoun-pronoun LLM can generate a negative reference-pair score to incompatible pronouns (e.g., to prevent incorrect matches) based on mismatches in gender, number, and/or animacy.

As also mentioned above, the plurality of candidate entity-matching LLMs 604 can include an entity-entity LLM. Specifically, the entity-entity LLM can focus on identifying, disambiguating, and/or generating reference-pair scores (or reference-group scores) for two or more entity references (e.g., an entity-entity reference pair) within a text. In some instances, by leveraging contextual embeddings, linguistic patterns, and/or machine learning techniques, the entity-entity LLM can resolve cases where different entity references—such as nouns or proper nouns, descriptive modifiers, abbreviations or acronyms, aliases, titles, and/or descriptive phrases—correspond to the same entity. In one or more embodiments, the entity-entity LLM can determine whether an entity mention is fully contained within another entity mention (e.g., “Franklin Madison” and “Frank Madison”) or whether two mentions exactly match (e.g., “USA” and “USA”).

As additionally mentioned above, the plurality of candidate entity-matching LLMs 604 can include a pronoun-entity LLM. In particular, the pronoun-entity LLM can focus on identifying, disambiguating, and/or generating reference-pair scores (or reference-group scores) for at least one pronoun reference and at least one entity reference (e.g., a pronoun-entity reference pair) within a text. In some cases, the pronoun-entity LLM leverages contextual embeddings, syntactic analysis, and/or deep learning to determine whether one or more pronoun references (e.g., “he”) and one or more entity references (e.g., “George Washington”) refer to the same entity. Indeed, the pronoun-entity LLM can accurately link pronoun references to their correct antecedents, even in some cases where multiple entity references are present or where pronoun references are ambiguous.

As further mentioned above, the plurality of candidate entity-matching LLMs 604 can include an alternative-reference LLM. Specifically, the alternative-reference LLM can focus on handling complex, ambiguous, implicit, and/or unconventional reference instance cases, including references that fall into neither the entity reference type nor the pronoun reference type. For instance, the alternative-reference LLM can leverage contextual embeddings, similarity-based embeddings, and/or probabilistic modeling to identify, disambiguate, and/or generate reference-pair scores (or reference-group scores) for reference pairs (or reference groups) involving at least one alternative reference within a text. See above for additional detail regarding the alternative-reference LLM.

In the same or other embodiments, the plurality of candidate entity-matching LLMs 604 can include one or more additional or alternative entity-matching LLMs. For instance, the coreference-determination system 100 can utilize a similarity entity-matching LLM that relies on similarity-based metrics to improve the accuracy of a coreference match. For example, the similarity entity-matching LLM may rely on string similarity distance (e.g., using Jaro-Winkler) to measure similarity between reference instances in the reference pair 602 (or a reference group). In some cases, the coreference-determination system 100 can direct (or route or provide) specific reference pairs or all reference pairs to the one or more additional or alternative entity-matching LLMs (e.g., the similarity entity-matching LLM).

As further illustrated in FIG. 6, the coreference-determination system 100 directs (or routes or provides) reference pairs (or reference groups) to a non-entity-matching LLM 606. In some embodiments, the coreference-determination system 100 directs all reference pairs (and/or reference groups) to the non-entity-matching LLM 606 in parallel to directing the reference pairs (and/or reference groups) to one of the plurality of candidate entity-matching LLMs 604, regardless of the reference type associated with each reference instance in the reference pairs. In some cases, a non-entity-matching LLM can generate a reference-pair score indicating a likelihood that a first reference instance and a second reference instance refer to the same entity. Additionally or alternatively, a non-entity-matching LLM can provide a broader linguistic and contextual assessment of textual references, such as serving as a foundational scoring mechanism for coreference resolution, to augment or supplement information extracted using the plurality of candidate entity-matching LLMs 604. Further, in at least one embodiment, the non-entity-matching LLM 606 is provided as a separate model apart from the plurality of candidate entity-matching LLMs 604 that operates in conjunction with a selected entity-matching LLM.

As shown in FIG. 6, the coreference-determination system 100 uses an entity-matching LLM in the plurality of candidate entity-matching LLMs 604 to generate a first confidence score 608. In particular, the coreference-determination system 100 can generate the first confidence score 608 to indicate the likelihood that the reference instances in the reference pair 602 (or a reference group) refer to the same entity. In some embodiments, the entity-matching LLM generates (or derives) the first confidence score 608 from one or more reference-pair scores the entity-matching LLM previously generated, as mentioned above. In one or more embodiments, the coreference-determination system 100 may use more than one entity-matching LLM in the plurality of candidate entity-matching LLMs 604 to generate a plurality of confidence scores. For example, the coreference-determination system 100 may direct (or route or provide) a reference pair (or reference group) to a first entity-matching LLM to generate a confidence score and simultaneously or sequentially to a second entity-matching LLM to generate an additional (or alternative) confidence score.

As also shown in FIG. 6, the coreference-determination system 100 uses the non-entity-matching LLM 606 to generate a second confidence score 610. In particular, the coreference-determination system 100 generates the second confidence score 610 to indicate another likelihood that the reference instances in a reference pair (or reference group) (e.g., the reference pair 602) refer to the same entity. In some embodiments, the non-entity-matching LLM 606 generates (or derives) the second confidence score 610 from one or more reference-pair scores the non-entity-matching LLM 606 previously generated, as mentioned above. As noted above, the coreference-determination system 100 generates the first confidence score 608 and the second confidence score 610 using different LLMs trained on different example data to complement one another in predicting coreference matches.

As further shown in FIG. 6, the coreference-determination system 100 generates a coreference match 612 for an entity. Specifically, the coreference-determination system 100 can combine the first confidence score 608 and the second confidence score 610 to generate a combined confidence score. In some cases, the combined confidence score can be a weighted confidence score (e.g., applying greater weight to the first confidence score 608 due to the specialization of the determined entity-matching LLM regarding the identified reference type) or an unweighted confidence score. Upon generating the combined confidence score, the coreference-determination system 100 can determine whether the combined confidence score is at or above a predefined threshold. If so, the coreference-determination system 100 may generate a coreference match 612, indicating that both reference instances in the reference pair 602 refer to the same entity in the text. As an example, consider the following: “Marie Curie was a pioneering scientist. She discovered radium.” From this exemplary text, the coreference-determination system 100 can determine that “Marie Curie” and “She” are coreference matches and that both refer to the same entity—Marie Curie. In some embodiments, the coreference-determination system 100 applies the non-entity-matching LLM 606 to generate the second confidence score 610 only after determining that the first confidence score 608 fails to satisfy a threshold. The coreference-determination system 100 can thus update a coreference prediction with both confidence score to either verify that no coreference match exists or to identify the coreference match 612 from the combined confidence score (even where the first confidence score 608 indicates no coreference match).

In one or more embodiments, the coreference-determination system 100 generates a coreference cluster. In particular, the coreference-determination system 100 can generate one or more coreference matches that collectively refer to a single entity. In response, the coreference-determination system 100 can generate the coreference cluster by linking (or associating or combining) the one or more coreference matches to one another. For instance, the coreference-determination system 100 can generate the coreference cluster by combining the one or more coreferences matches into a set or cluster of coreference instances that collectively refer to the same entity. In some embodiments, the coreference-determination system 100 can generate a plurality of coreference clusters for a plurality of entities identified in, e.g., a genealogical-record text.

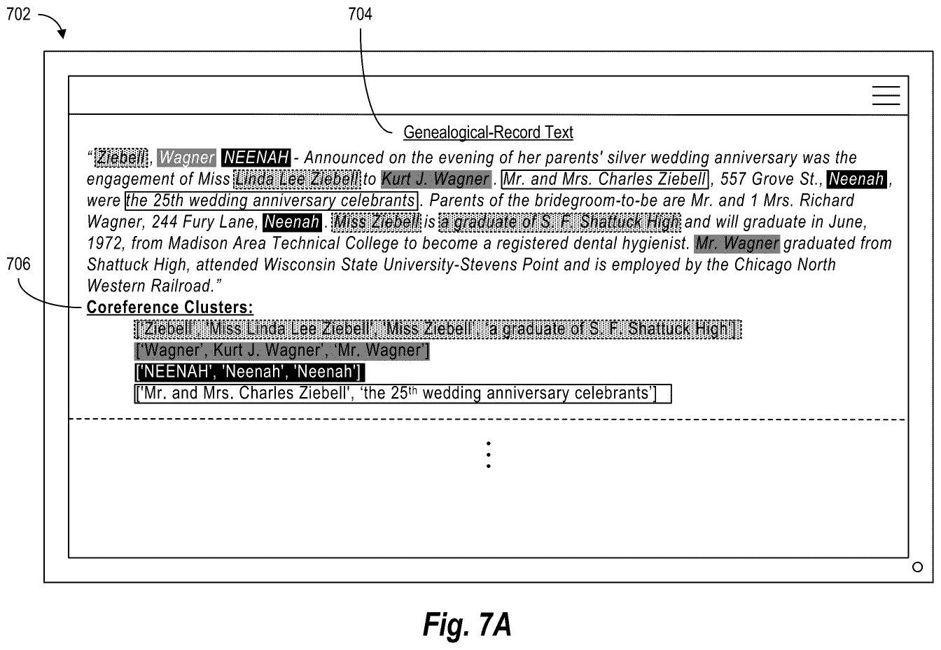

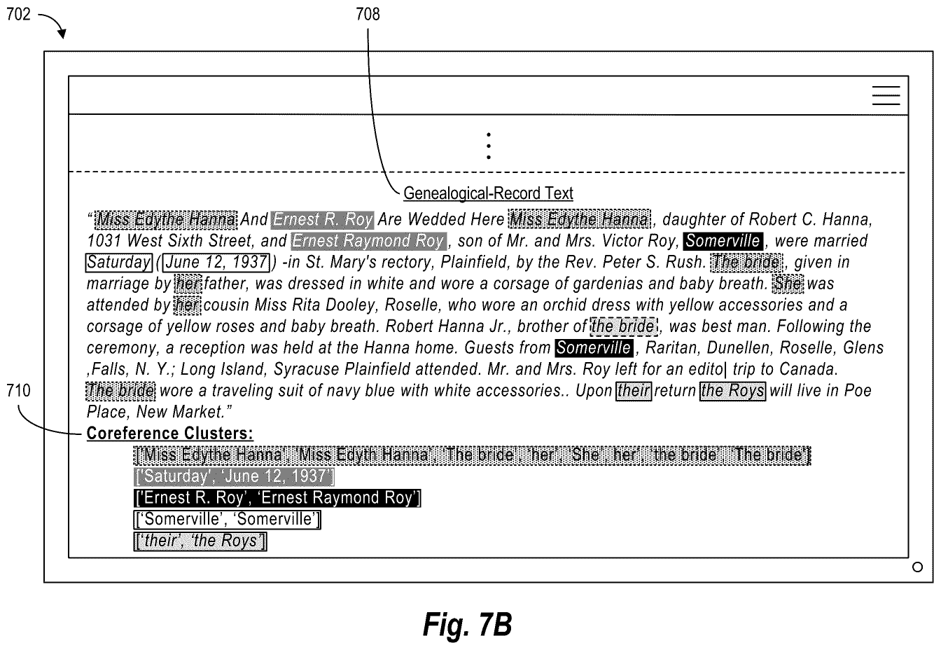

As expressed above, the coreference-determination system 100 can generate coreference clusters for a plurality of entities. In particular, the coreference-determination system 100 can generate coreference clusters by combining coreference matches into a sets of coreference instances the each collectively refer to the same entity. FIGS. 7A-7B illustrate example user interfaces for generating coreference clusters in accordance with one or more embodiments.

As illustrated in FIGS. 7A-7B, the coreference-determination system 100 can provide, for display in a client device, a coreference management interface 702. In some embodiments, the coreference management interface 702 displays one or more genealogical-record texts. In the same or other embodiments, the coreference management interface 702 displays generated (or predicted) coreference clusters from reference instances in the genealogical-record text.

For instance, as illustrated in FIG. 7A, the coreference management interface 702 may display genealogical-record text 704. In one or more embodiments, the coreference management interface 702 can display coreference clusters 706. For example, from the genealogical-record text 704, the coreference-determination system 100 may generate, and provide for display in the coreference management interface 702, a coreference cluster 706 for the entity, “Linda Lee Ziebell,” wherein the cluster can include instances from the genealogical-record text including “Ziebell,” “Miss Linda Lee Ziebell,” “Miss Ziebell,” and “a graduate of S.F. Shattuck High.” As other examples, from the genealogical-record text 704, the coreference-determination system 100 may generate, and provide for display in the coreference management interface 702, a coreference cluster 706 for each of the following entities: “Kurt J. Wagner,” “Neenah,” and/or “Mr. and Mrs. Charles Ziebell,” as shown in FIG. 7A.

As also illustrated in FIG. 7B, the coreference management interface 702 may display genealogical-record text 708 that is different than, or a continuation of, genealogical-record text 704. In one or more embodiments, the coreference management interface 702 can display coreference clusters 710. For example, from the genealogical-record text 708, the coreference-determination system 100 may generate, and provide for display in the coreference management interface 702, a coreference cluster 710 for the entity, “Edyth Hanna,” wherein the cluster can include “Miss Edythe Hanna,” “Miss Edyth Hanna,” “The bride,” “her,” “She,” “her,” “the bride,” and “the bride” as identified from the genealogical-record text 708. As other examples from the genealogical-record text 708, the coreference-determination system 100 may generate, and provide for display in the coreference management interface 702, a coreference cluster 710 for each of the following entities: a date of “Jun. 12, 1937,” “Ernest R. Roy,” a location of “Somerville,” and/or “the Roys,” as shown in FIG. 7B.

In some cases, relating to FIG. 7A and FIG. 7B, the coreference-determination system 100 can receive a selection of a reference instance and/or a coreference cluster (e.g., from the coreference clusters 706 or 710). Indeed, the coreference-determination system 100 can receive a selection in the form of a click or a tap within the coreference management interface 702. In response to the selection, the coreference-determination system 100 can identify and highlight (or otherwise visually indicate or portray) other reference instances from the text body that are coreference matches of the selected reference instance.

Further in relation to FIG. 7A and FIG. 7B, the coreference-determination system 100 can predict (or determine and/or classify) a gender for a particular entity. For example, the coreference-determination system 100 uses a gender-prediction model to predict (or determine and/or classify) a gender for a particular entity based on coreference matches, coreference clusters, reference instances, and/or contextual data associated with the genealogical-record text, as explained in greater detail above. To illustrate, referring to FIG. 7A, the coreference-determination system 100 may use a gender-prediction model to predict (or determine and/or classify) that the gender associated with the coreference cluster for the entity “Linda Lee Ziebell” is female. In making this prediction, the gender-prediction model may consider factors, such as the prefix “Miss” (which corresponds to a female prefix), the name “Linda” (which often is associated with the female gender), and/or various contextual cues within the text.

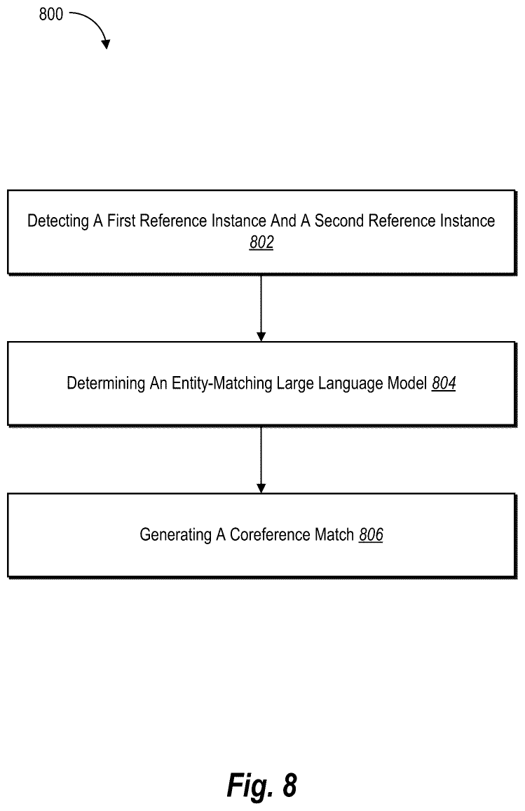

FIGS. 1-7, the corresponding text, and the examples provide a number of different systems and methods for generating coreference matches. In addition to the foregoing, implementations can also be described in terms of flowcharts comprising acts steps in a method for accomplishing a particular result. For example, FIG. 8 illustrate example series of acts for generating a coreference match.

While FIG. 8 illustrates acts according to certain implementations, alternative implementations may omit, add to, reorder, and/or modify any of the acts shown in FIG. 8. The acts of FIG. 8 can be performed as part of a method. Alternatively, a non-transitory computer-readable medium can comprise instructions, that when executed by one or more processors, cause a computing device to perform the acts of FIG. 8. In still further implementations, a system can perform the acts of FIG. 8.

As illustrated in FIG. 8, the series of acts 800 includes an act 802 of detecting a first reference instance and a second reference instance. In particular, the act 802 involves detecting, from a genealogical-record text, a first reference instance corresponding to an entity in the genealogical-record text and a second reference instance corresponding to the entity in the genealogical-record text. In addition, the series of acts 800 includes an act 804 of determining an entity-matching large language model. In particular, the act 804 involves determining, using a model-selection router, an entity-matching large language model corresponding to the first reference instance and the second reference instance from among a plurality of candidate entity-matching large language models comprising at least an entity-entity large language model. As shown, the series of acts 800 includes an act 806 of generating a coreference match. For example, the act 806 involves generating a coreference match for the entity indicated by the first reference instance and the second reference instance utilizing the entity-matching large language model.

In some embodiments, the series of acts 800 includes an act of encoding, using a multilingual encoder, the first reference instance to generate a first vector representation and the second reference instance to generate a second vector representation. In these or other embodiments, the series of acts 800 includes an act of providing, using the model-selection router comprising multilingual heuristics, the first vector representation and the second vector representation to the entity-matching large language model for analysis.

The series of acts 800 can include an act of determining the entity-matching large language model by: determining that the first reference instance and the second reference instance each correspond to a reference type from a plurality of reference types comprising a pronoun reference type and an entity reference type; and selecting, from among the plurality of candidate entity-matching large language models, the entity-entity large language model, a pronoun-pronoun large language model, or a pronoun-entity large language model based on the reference type for each of the first reference instance and the second reference instance. In some embodiments, the series of acts 800 includes an act of determining the entity-matching large language model by: determining that at least one of the first reference instance or the second reference instance is not a pronoun reference or an entity reference; and selecting, from among the plurality of candidate entity-matching large language models, an alternative-reference large language model for generating the coreference match for the entity.

In some embodiments, the series of acts 800 includes an act of determining the entity-matching large language model by: determining that at least one of the first reference instance or the second reference instance is an unknown reference or a text-inconsistency reference; and selecting, from among the plurality of candidate entity-matching large language models, an alternative-reference large language model for generating the coreference match for the entity. The series of acts 800 can also include an act of generating the coreference match for the entity by associating, in response to determining that at least one of the first reference instance or the second reference instance is an unknown reference or a text-inconsistency reference, the first reference instance with the second reference instance based on analyzing the genealogical-record text utilizing the alternative-reference large language model.

In one or more embodiments, the series of acts 800 includes an act of generating the coreference match by: utilizing the entity-matching large language model to generate a first confidence score indicating a likelihood that the first reference instance and the second reference instance refer to the entity; generating, utilizing a non-entity-matching large language model, a second confidence score indicating a second likelihood as to whether the first reference instance and the second reference instance refer to the entity; and combining the first confidence score and the second confidence score.

Additionally, the series of acts 800 includes an act of generating the coreference match for the entity by: determining that at least one of the first reference instance or the second reference instance is an unknown reference or a text-inconsistency reference; selecting, from among the plurality of candidate entity-matching large language models, an alternative-reference large language model for generating the coreference match for the entity; and associating the first reference instance with the second reference instance based on analyzing the genealogical-record text utilizing the alternative-reference large language model.

It will be appreciated that while the coreference-determination system 100 embodiments have been described, the disclosure is not limited thereto. Rather, the disclosure extends to any suitable application of the disclosed embodiments in any suitable context, such as with regards to financial records, medical records, legal records, or other data types.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of exemplary computing device 900 (e.g., the server(s) 102 and/or the client device 108) that may be configured to perform one or more of the processes described above. One will appreciate that server(s) 102 and/or the client device 108 may comprise one or more computing devices such as computing device 900. As shown by FIG. 9, computing device 900 can comprise processor 902, memory 904, storage device 906, I/O interface 908, and communication interface 910, which may be communicatively coupled by way of communication infrastructure 912. While an exemplary computing device 900 is shown in FIG. 9, the components illustrated in FIG. 9 are not intended to be limiting. Additional or alternative components may be used in other implementations. Furthermore, in certain implementations, computing device 900 can include fewer components than those shown in FIG. 9. Components of computing device 900 shown in FIG. 9 will now be described in additional detail.

In particular implementations, processor 902 includes hardware for executing instructions, such as those making up a computer program. As an example and not by way of limitation, to execute instructions, processor 902 may retrieve (or fetch) the instructions from an internal register, an internal cache, memory 904, or storage device 906 and decode and execute them. In particular implementations, processor 902 may include one or more internal caches for data, instructions, or addresses. As an example and not by way of limitation, processor 902 may include one or more instruction caches, one or more data caches, and one or more translation lookaside buffers (TLBs). Instructions in the instruction caches may be copies of instructions in memory 904 or storage device 906.

Memory 904 may be used for storing data, metadata, and programs for execution by the processor(s). Memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 904 may be internal or distributed memory.

Storage device 906 includes storage for storing data or instructions. As an example and not by way of limitation, storage device 906 can comprise a non-transitory storage medium described above. Storage device 906 may include a hard disk drive (HDD), a floppy disk drive, flash memory, an optical disc, a magneto-optical disc, magnetic tape, or a Universal Serial Bus (USB) drive or a combination of two or more of these. Storage device 906 may include removable or non-removable (or fixed) media, where appropriate. Storage device 906 may be internal or external to computing device 900. In particular implementations, storage device 906 is non-volatile, solid-state memory. In other implementations, Storage device 906 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 908 allows a user to provide input to, receive output from, and otherwise transfer data to and receive data from computing device 900. I/O interface 908 may include a mouse, a keypad or a keyboard, a touch screen, a camera, an optical scanner, network interface, modem, other known I/O devices or a combination of such I/O interfaces. I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 908 is configured to provide graphical data to a display for presentation to a user. The graphical data may be representative of one or more graphical user interfaces and/or any other graphical content as may serve a particular implementation.

Communication interface 910 can include hardware, software, or both. In any event, communication interface 910 can provide one or more interfaces for communication (such as, for example, packet-based communication) between computing device 900 and one or more other computing devices or networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 910 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 910 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 912 may include hardware, software, or both that couples components of computing device 900 to each other. As an example and not by way of limitation, communication infrastructure 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 10 is a schematic diagram illustrating environment 1000 within which one or more implementations of the coreference-determination system 100 can be implemented. For example, the coreference-determination system 100 may be part of a genealogical data system 1002 (e.g., the genealogical data system 104). The genealogical data system 1002 may generate, store, manage, receive, and send digital content (such as genealogical content items like genealogical-record texts). For example, genealogical data system 1002 may send and receive digital content to and from client devices 1006 by way of network 1004. In particular, genealogical data system 1002 can store and manage genealogical databases for various user accounts, historical records, genealogical-record texts, and genealogy trees. In some embodiments, the genealogical data system 1002 can manage the distribution and sharing of digital content between computing devices associated with user accounts. For instance, the genealogical data system 1002 can facilitate a user account sharing a genealogical content item with another user account of genealogical data system 1002.

In particular, the genealogical data system 1002 can manage synchronizing digital content across multiple client devices 1006 associated with one or more user accounts. For example, a user may edit a digitized historical document or a node within a genealogy tree using client device 1006. The genealogical data system 1002 can cause client device 1006 to send the edited genealogical content to the genealogical data system 1002, whereupon the genealogical data system 1002 synchronizes the genealogical content on one or more additional computing devices.

As shown, the client device 1006 may be a desktop computer, a laptop computer, a tablet computer, an augmented reality device, a virtual reality device, a personal digital assistant (PDA), an in-or out-of-car navigation system, a handheld device, a smart phone or other cellular or mobile phone, or a mobile gaming device, other mobile device, or other suitable computing devices. The client device 1006 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1004.

The network 1004 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1006 may access genealogical data system 1002.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
detecting, from a genealogical-record text, a first reference instance corresponding to an entity in the genealogical-record text and a second reference instance corresponding to the entity in the genealogical-record text;
determining, using a model-selection router, an entity-matching large language model corresponding to the first reference instance and the second reference instance from among a plurality of candidate entity-matching large language models comprising at least an entity-entity large language model; and
generating a coreference match for the entity indicated by the first reference instance and the second reference instance utilizing the entity-matching large language model.

2. The computer-implemented method of claim 1, further comprising encoding, using a multilingual encoder, the first reference instance to generate a first vector representation and the second reference instance to generate a second vector representation.

3. The computer-implemented method of claim 2, further comprising providing, using the model-selection router comprising multilingual heuristics, the first vector representation and the second vector representation to the entity-matching large language model for analysis.

4. The computer-implemented method of claim 1, wherein determining the entity-matching large language model comprises:
determining that the first reference instance and the second reference instance each correspond to a reference type from a plurality of reference types comprising a pronoun reference type and an entity reference type; and
selecting, from among the plurality of candidate entity-matching large language models, the entity-entity large language model, a pronoun-pronoun large language model, or a pronoun-entity large language model based on the reference type for each of the first reference instance and the second reference instance.

5. The computer-implemented method of claim 1, wherein determining the entity-matching large language model comprises:
determining that at least one of the first reference instance or the second reference instance is not a pronoun reference or an entity reference; and
selecting, from among the plurality of candidate entity-matching large language models, an alternative-reference large language model for generating the coreference match for the entity.

6. The computer-implemented method of claim 1, wherein determining the entity-matching large language model comprises:
determining that at least one of the first reference instance or the second reference instance is an unknown reference or a text-inconsistency reference; and
selecting, from among the plurality of candidate entity-matching large language models, an alternative-reference large language model for generating the coreference match for the entity.

7. The computer-implemented method of claim 6, wherein generating the coreference match for the entity comprises associating, in response to determining that at least one of the first reference instance or the second reference instance is an unknown reference or a text-inconsistency reference, the first reference instance with the second reference instance based on analyzing the genealogical-record text utilizing the alternative-reference large language model.

8. The computer-implemented method of claim 1, wherein generating the coreference match comprises:
utilizing the entity-matching large language model to generate a first confidence score indicating a likelihood that the first reference instance and the second reference instance refer to the entity;
generating, utilizing a non-entity-matching large language model, a second confidence score indicating a second likelihood as to whether the first reference instance and the second reference instance refer to the entity; and
combining the first confidence score and the second confidence score.

9. A system comprising:
at least one processor; and
at least one non-transitory computer-readable storage medium storing instructions that, when executed by the at least one processor, cause the system to:
detect, from a genealogical-record text, a first reference instance corresponding to an entity in the genealogical-record text and a second reference instance corresponding to the entity in the genealogical-record text;
encode, using a multilingual encoder, the first reference instance to generate a first vector representation and the second reference instance to generate a second vector representation;
determine, using a model-selection router, an entity-matching large language model corresponding to the first vector representation and the second vector representation from among a plurality of candidate entity-matching large language models; and
generate a coreference match for the entity indicated by the first reference instance and the second reference instance utilizing the entity-matching large language model.

10. The system of claim 9, further comprising instructions that, when executed by the at least one processor, cause the system to provide, using the model-selection router comprising multilingual heuristics, the first vector representation and the second vector representation to the entity-matching large language model for analysis.

11. The system of claim 9, further comprising instructions that, when executed by the at least one processor, cause the system to determine the entity-matching large language model by:
determining that the first reference instance and the second reference instance each correspond to a reference type from a plurality of reference types comprising a pronoun reference type and an entity reference type; and
selecting, from among the plurality of candidate entity-matching large language models, an entity-entity large language model, a pronoun-pronoun large language model, or a pronoun-entity large language model based on the reference type for each of the first reference instance and the second reference instance.

12. The system of claim 9, further comprising instructions that, when executed by the at least one processor, cause the system to determine the entity-matching large language model by:
determining that at least one of the first reference instance or the second reference instance is not a pronoun reference or an entity reference; and
selecting, from among the plurality of candidate entity-matching large language models, an alternative-reference large language model for generating the coreference match for the entity.

13. The system of claim 9, further comprising instructions that, when executed by the at least one processor, cause the system to determine the entity-matching large language model by:
determining that at least one of the first reference instance or the second reference instance is an unknown reference or a text-inconsistency reference; and
selecting, from among the plurality of candidate entity-matching large language models, an alternative-reference large language model for generating the coreference match for the entity.

14. The system of claim 13, further comprising instructions that, when executed by the at least one processor, cause the system to generate the coreference match for the entity by associating, in response to determining that at least one of the first reference instance or the second reference instance is an unknown reference or a text-inconsistency reference, the first reference instance with the second reference instance based on analyzing the genealogical-record text utilizing the alternative-reference large language model.

15. The system of claim 9, further comprising instructions that, when executed by the at least one processor, cause the system to generate the coreference match by:
utilizing the entity-matching large language model to generate a first confidence score indicating a likelihood that the first reference instance and the second reference instance refer to the entity;
generating, utilizing a non-entity-matching large language model, a second confidence score indicating a second likelihood as to whether the first reference instance and the second reference instance refer to the entity; and
combining the first confidence score and the second confidence score.

16. A non-transitory computer-readable medium storing instructions that, when executed by at least one processor, cause a computing device to:
detect, from a genealogical-record text, a first reference instance corresponding to an entity in the genealogical-record text and a second reference instance corresponding to the entity in the genealogical-record text;
encode, using a multilingual encoder, the first reference instance into a first vector representation and the second reference instance into a second vector representation;
determine, using a model-selection router, an entity-matching large language model corresponding to the first vector representation and the second vector representation from among a plurality of candidate entity-matching large language models comprising at least an entity-entity large language model; and
generate a coreference match for the entity indicated by the first reference instance and the second reference instance utilizing the entity-matching large language model.

17. The non-transitory computer-readable medium of claim 16, further comprising instructions that, when executed by the at least one processor, cause the computing device to provide, using the model-selection router comprising multilingual heuristics, the first vector representation and the second vector representation to the entity-matching large language model for analysis.

18. The non-transitory computer-readable medium of claim 16, further comprising instructions that, when executed by the at least one processor, cause the computing device to determine the entity-matching large language model by:
determining that the first reference instance and the second reference instance each correspond to a reference type from a plurality of reference types comprising a pronoun reference type and an entity reference type; and
selecting, from among the plurality of candidate entity-matching large language models, the entity-entity large language model, a pronoun-pronoun large language model, or a pronoun-entity large language model based on the reference type for each of the first reference instance and the second reference instance.

19. The non-transitory computer-readable medium of claim 16, further comprising instructions that, when executed by the at least one processor, cause the computing device to generate the coreference match for the entity by:
determining that at least one of the first reference instance or the second reference instance is an unknown reference or a text-inconsistency reference;
selecting, from among the plurality of candidate entity-matching large language models, an alternative-reference large language model for generating the coreference match for the entity; and
associating the first reference instance with the second reference instance based on analyzing the genealogical-record text utilizing the alternative-reference large language model.

20. The non-transitory computer-readable medium of claim 16, further comprising instructions that, when executed by the at least one processor, cause the computing device to generate the coreference match by:
utilizing the entity-matching large language model to generate a first confidence score indicating a likelihood that the first reference instance and the second reference instance refer to the entity;
generating, utilizing a non-entity-matching large language model, a second confidence score indicating a second likelihood as to whether the first reference instance and the second reference instance refer to the entity; and
combining the first confidence score and the second confidence score.
